(19) United States
(12) Patent Application Publication
(10) Pub. No.: US 2014/0258825 A1
(43) Pub. Date: Sep. 11, 2014

(54) SYSTEMS AND METHODS FOR AUTOMATED FORM GENERATION

(71) Applicants: Tuhin Ghosh, Valley Center, CA (US); Terry Freund, Syracuse, NY (US)

(72) Inventors: Tuhin Ghosh, Valley Center, CA (US); Terry Freund, Syracuse, NY (US)

(21) Appl. No.: 13/790,824

(22) Filed: Mar. 8, 2013

(51) Int. Cl. G06F 17/24

(52) U.S. Cl. CPC G06F 17/243
USPC 715/222

(57) ABSTRACT

Systems and methods acquire inspection information and reporting data from a scanned image of a paper inspection form. Inspection information can be extracted and converted to electronic format. The electronic format can be downloaded to a mobile device to facilitate an inspection during an inspection process. The inspection results can be entered into the mobile device and saved electronically, and can be automatically generated on a printed paper inspection form when desired.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The subject matter disclosed herein relates generally to systems and method for automating form generation, and more particularly, to systems and methods that extract information from paper-based forms, convert the extracted information to an electronic format, and generate an electronic form for electronic use.

As a representative example, paper-based forms have been used by different organizations as a way to document, and prove if necessary, that compliance inspections have been performed. In some areas, such as a work place, compliance inspections can be regulated by an authority having jurisdiction (AHJ). The compliance inspections can be regulated according to the guidelines and schedules published by the AHJ. These compliance inspections are primarily scheduled inspections, meaning they can have a pre-defined time frequency of required execution and are designed to prevent work place accidents, loss of live and property, for example. Most AHJs require completion of such inspections on a timely basis and in some cases can penalize organizations that fail to comply with the inspection regulations.

Currently, an inspector that performs the required inspections, typically an employee of the organization, makes a copy or copies of a pre-authorized paper inspection form and carries the paper inspection form with them during inspection of an inspection site. During inspection, the inspector follows inspection steps described on the paper form and manually fills in required inspection information on the paper form. The results of each step are documented and an overall summary of the inspection is prepared. During the course of a single site inspection, the inspector can use and fill in multiple different paper forms, typically one for each piece of equipment inspected during the site inspection.

On completion of a site inspection, the inspector can turn in the pre-authorized paper inspection forms to a supervisor, for example, who then sends a copy of the paper inspection form to the AHJ and files a copy of the paper inspection form for internal use and record keeping. Retaining a copy for records is important because during an audit, a compliance officer from the AHJ can request proof of an inspection history for a randomly selected list of equipment.

The organization then has the burden of sorting through their records of paper inspection forms to produce the requested inspection history for the list of equipment requested by the compliance officer. The act of sorting through stacks of inspection forms is time consuming and is an inefficient use of productive time. Also, the written data on the paper inspection form can be illegible as it was manually filled in by the inspector, and can result in a wrong interpretation of the inspection results.

Therefore, a need exists to minimize or eliminate manual documentation of inspection data on paper-based inspection forms to document inspection results and to avoid inefficient use of productive time to retrieve historical inspection information.

It would, therefore be desirable to provide systems and methods where a user can scan a paper-based form to automatically extract information and convert the extracted information to electronic format, which can then be downloaded to a mobile device for electronic use.

### BRIEF DESCRIPTION OF THE INVENTION

The present embodiments overcomes the aforementioned problems by providing systems and methods that acquire inspection information and reporting data from a scanned image of a paper inspection form, extract inspection information and convert the inspection information to electronic format in order to facilitate an inspection process during an inspection using a mobile device. A user can scan a paper-based form to extract the inspection information and convert the extracted information to electronic format, which can then be downloaded to the mobile device to facilitate the inspection process. The inspection results can be saved electronically and can be automatically generated on a printed paper inspection form when desired.

In some embodiments, an electronic form generation system can include a processor, the processor being operatively coupled to a monitor. A scanning application can be in communication with the processor, with the scanning application to enable a user to scan a paper form using a scanner and convert the paper form into an electronic file. A compliance application can be in communication with the processor, the compliance application to upload the electronic file to a database. An extraction application can use optical character recognition to process the electronic file to extract and then output an inspection workflow file. An item list generation application can be viewable on the monitor, the item list generation application to generate an electronic item list, the item list generation application to allow the user to select at least one inspection item from the inspection workflow file and to add the at least one selected inspection item to the electronic item list, the electronic item list to be stored in the database for future retrieval and use. A mobile inspection application can be used on a mobile electronic device, and can be used to download and access the electronic item list and to allow the user to enter collected data using the mobile device.

In other embodiments, an electronic compliance form generation system can include a document scanning application operable on a processor, the document scanning application to enable a user to scan a paper compliance form using a scanner and convert the paper compliance form into an electronic file. An extraction application can use character recognition to process the electronic file to extract and then output a compliance inspection workflow file. An item list generation application can be used to generate an electronic inspection question set based on the paper compliance form, the electronic inspection question set to be stored in a database for future retrieval and use. A mobile compliance inspection application can be operable on a mobile electronic device, the mobile compliance inspection application operable to download and access the electronic inspection question set and to allow the user to enter collected compliance data using the mobile device. A document generator application can be used to incorporate the collected compliance data with the electronic inspection question set to create an electronic report file of the paper compliance form. The electronic report file can be printed as a paper report, the paper report including the collected inspection data.

In yet other embodiments, a method of performing an inspection can include the steps of uploading an electronic file to a compliance application, the compliance application including an extraction application and an item list generation application; using the extraction application to process the electronic file and output an inspection workflow file; using the item list generation application to highlight an inspection item from the inspection workflow file that will be used to generate an electronic item list; downloading the electronic item list to a mobile device; accessing the downloaded electronic item list using a mobile compliance inspection application; and performing the inspection based on downloaded electronic item list.

To the accomplishment of the foregoing and related ends, the embodiments, then, comprise the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE DRAWINGS

The embodiments will hereafter be described with reference to the accompanying drawings, wherein like reference numerals denote like elements, and:

FIG. 1 is a schematic view of an electronic form generation and tracking system according to an embodiment of the invention;

FIG. 2 is a schematic view of an extraction portion of an electronic form generation and tracking system according to an embodiment of the invention;

FIG. 3 is a schematic view of an item list generation portion of an electronic form generation and tracking system according to an embodiment of the invention;

FIG. 4 is a schematic view of another section of the item list generation portion of an electronic form generation and tracking system according to an embodiment of the invention;

FIG. 5 is a view of a screen on a display showing an item list according to an embodiment of the invention;

FIG. 6 is a schematic view of an embodiment of a workflow associated with an electronic form generation and tracking system according to an embodiment of the invention; and

FIG. 7 is a flow chart illustrating a method that may be performed in accordance with embodiments of the schematic diagram illustrated in FIG. 1.

### DETAILED DESCRIPTION OF THE INVENTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein.

The detailed description is to be read with reference to the figures. The figures depict selected embodiments and are not intended to limit the scope of embodiments of the invention. Skilled artisans will recognize the examples provided herein have many useful alternatives and fall within the scope of embodiments of the invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless specified or limited otherwise, the terms “connected” and “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically. Thus, although schematics shown in the figures depict example arrangements of processing elements, additional intervening elements, devices, features, components, or code may be present in an actual embodiment.

As used herein, the term “processor” and variations thereof is used broadly and can include one or more processors and memories and/or one or more programmable hardware elements. As used herein, these terms are intended to include any of types of processors, CPUs, microprocessors, microcontrollers, digital signal processors, or other devices capable of executing software instructions.

Various embodiments of the invention may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, diodes, look-up tables, etc., which may carry out a variety of functions under the control of one or more microprocessors or other control devices. Other embodiments may employ program code, or code in combination with other circuit components.

In accordance with the practices of persons skilled in the art of computer programming, the present disclosure may be described herein with reference to symbolic representations of operations that may be performed by various computing components, modules, or devices. Such operations may be referred to as being computer-executed, computerized, software-implemented, or computer-implemented. It will be appreciated that operations that can be symbolically represented include the manipulation by the various processor devices of electrical signals representing data bits at memory locations in the system memory, as well as other processing of signals. The memory locations where data bits are maintained are physical locations that have particular electrical, magnetic, optical, or organic properties corresponding to the data bits.

The various embodiments of the invention will be described in connection with systems and methods for the generation and use of electronic compliance inspection forms. That is because the features and advantages of the invention are well suited for this purpose. Still, it should be appreciated that the various aspects of the invention can be applied to other paper and electronic forms and in other industries and processes capable of utilizing a form that is typically maintained for record keeping purposes.

Specific paper forms, such as paper inspection compliance forms, are typically used to track inspections for fire and safety equipment, environmental health and safety equipment and locations, cranes/aerial equipment, property/building condition, laboratory equipment, mining, oil and gas equipment, correctional facility equipment, and pest management, all as non-limiting examples.

Though described with respect to a compliance inspection used in most business settings, one of ordinary skill in the art can extend the concepts disclosed herein to most any other application where information about a device is desired. Other applications may allow the generation and printing of device instructions or other procedural information about the device, for example.

Inspection compliance has been primarily a pen and paper industry and often requires filling out internal and/or federal/state mandated forms. Some applications exist, such as InspectNTrack by Brady Corporation of Milwaukee, Wis., that help to automate only small portions of the overall process. However, these applications require manual data-entry of the form and hard-coding of forms in the application. This can be time consuming and is prone to errors. Still further, most of these applications only implement a handful of federal forms, so the internal forms used by companies never gets automated, and it remains a tedious process to ensure that the federal and state mandated forms implemented in these applications are up to date. Using an outdated form can cause non-compliance.

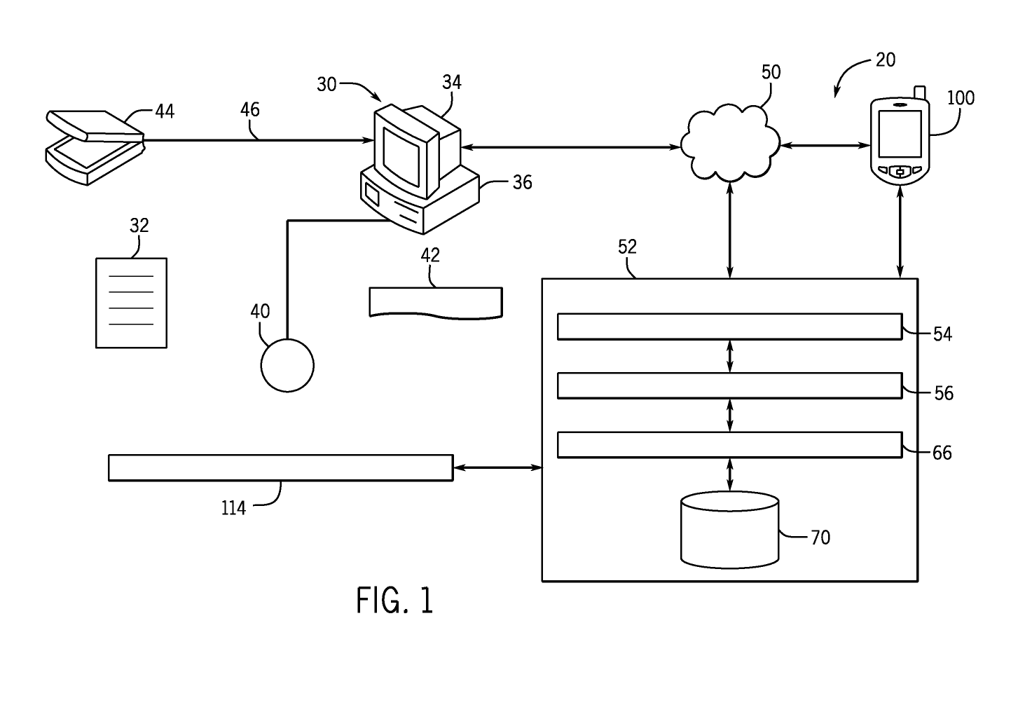

Referring now to the drawings wherein like reference numbers correspond to similar components throughout the several views and, specifically, referring now to FIG. 1, embodiments of the invention shall be described in the context of an electronic form generation and tracking system 20. The electronic form generation and tracking system 20 illustrates an exemplary embodiment of the systems and methods for the generation and use of electronic compliance inspection forms.

The electronic form generation and tracking system 20 can allow a user to upload any known or future developed type of paper or electronic form, e.g., PDF, MS Word, Text, Excel, and an image, e.g., GIF, TIF, JPG, PNG, as non-limiting examples. Using OCR (optical character recognition) or other text or image processing algorithm, the uploaded form can be converted into an electronic file 42, if not already in a digital form. The user can select all or sections of the electronic file 42 to define an electronic inspection question set 94 by selecting area(s) using a mouse to draw a box on the digital document to represent a position on the electronic inspection question set 94 where inspection results can or should appear. The user can then download the electronic inspection question set 94 into a mobile device and perform the inspection without the need for a paper form. Once the inspection is performed, or during the inspection, the inspection results (collected inspection data) can be uploaded to a server or other storage, for example, and a completed inspection form can be automatically generated (filled in with the collected inspection data), and can be electronically stored for inspection audit and/or printing and/or for further data mining. The completed inspection form and associated collected inspection data can be arranged into a variety of report formats.

The systems and methods can increase automation efficiency, as the user can upload any kind of documents without making any changes to the underlying form generation and tracking system. Also, by storing the gathered inspection data in a searchable format instead of hard-coded paper documents, the systems and methods can allow a user to perform trending analysis on inspection needs and deficiencies, for example.

In the embodiment shown in FIG. 1, processor 30 can be used to perform a variety of tasks involved in automating a paper form 32. In the embodiment shown, the processor can be a computer system 30 including a monitor 34 and memory 36, for example. A user can have access to a scanning application 40 on or in communication with the computer system 30. The scanning application 40 can enable the user to scan the paper form 32 into an electronic file 42, e.g., a digitally scanned electronic file, using a digital scanner 44, for example. The digital scanner 44 can communicate 46 with the computer system 30 through known industry established protocols, such as a direct USB connection, WiFi or Bluetooth, as non-limiting examples.

After the paper form 32 has been scanned and converted into the electronic file 42, in some embodiments, the user can use the Internet 50 to access a compliance application 52 to upload the electronic file 42 for processing. In some embodiments, the compliance application 52 can be a cloud based application. It is to be appreciated that compliance application 52 can also be accessible on the computer system 30, or across a local area network, for example, as would be known to one skilled in the art.

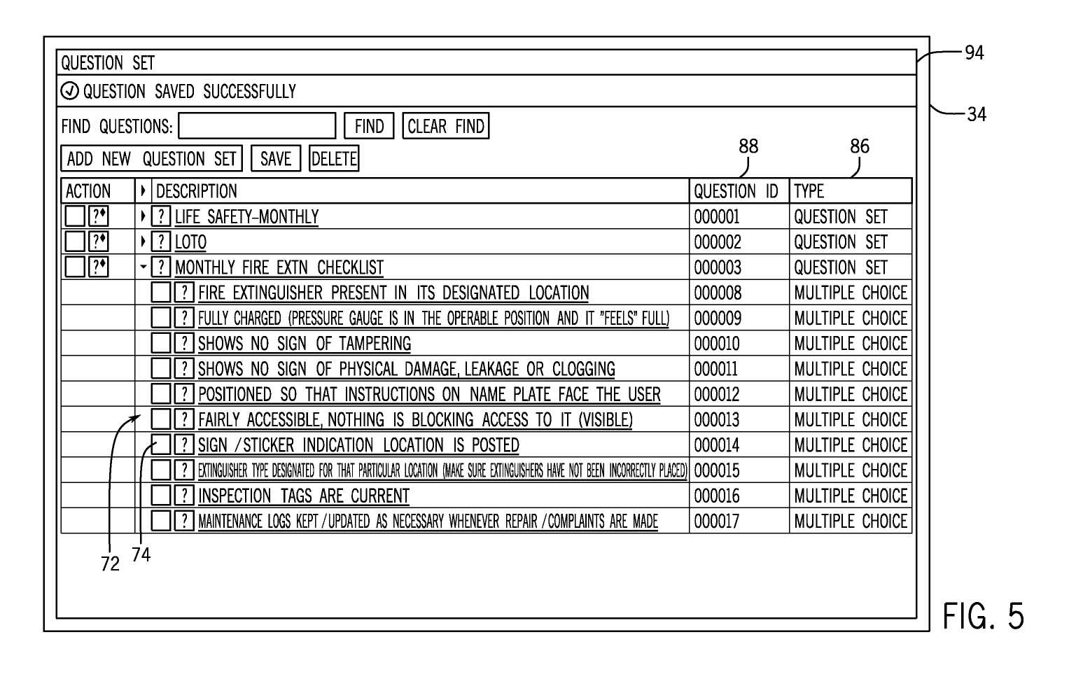

In some embodiments, such as where the compliance application is a cloud or web based customer portal 52, the user may be required to provide access information. After the user has been authenticated, they can then have access to a scanned document upload interface 54. The scanned document upload interface 54 can be used to allow the user to browse the electronic files 42 electronically stored on the computer system 30 or elsewhere. The user can select a desired electronic file 42, and then submit the electronic file 42 for uploading to an extraction application 56. An item list generation application 66 can then be used to generate an electronic item list 94 (see FIG. 5), where in some embodiments, the electronic item list 94 can be an electronic inspection question set. The electronic inspection question set 94 can be stored in database 70 for future retrieval and use.

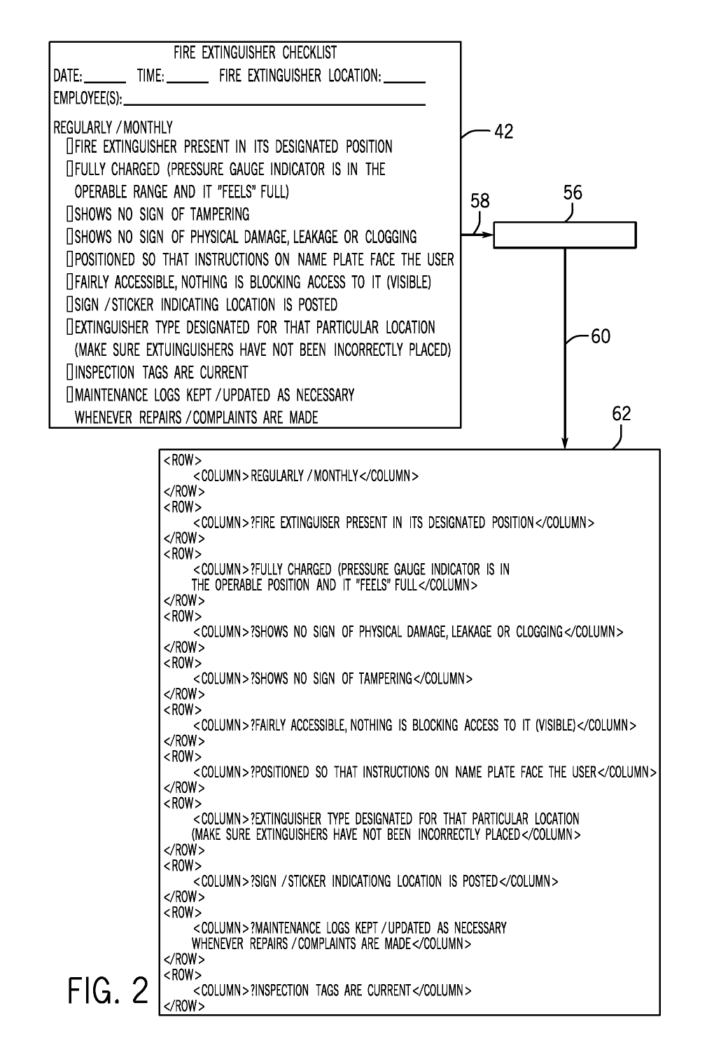

Portions of the web application 52 will now be described in greater detail. Referring to FIGS. 2 through 5, once the desired electronic file 42, e.g., in PDF form, is uploaded 58 to the extraction application 56, the extraction application 56 can use optical character recognition (OCR) or other known suitable character recognition technologies to process the electronic file 42 to extract and then output 60 an inspection workflow file 62 in a XML format, for example.

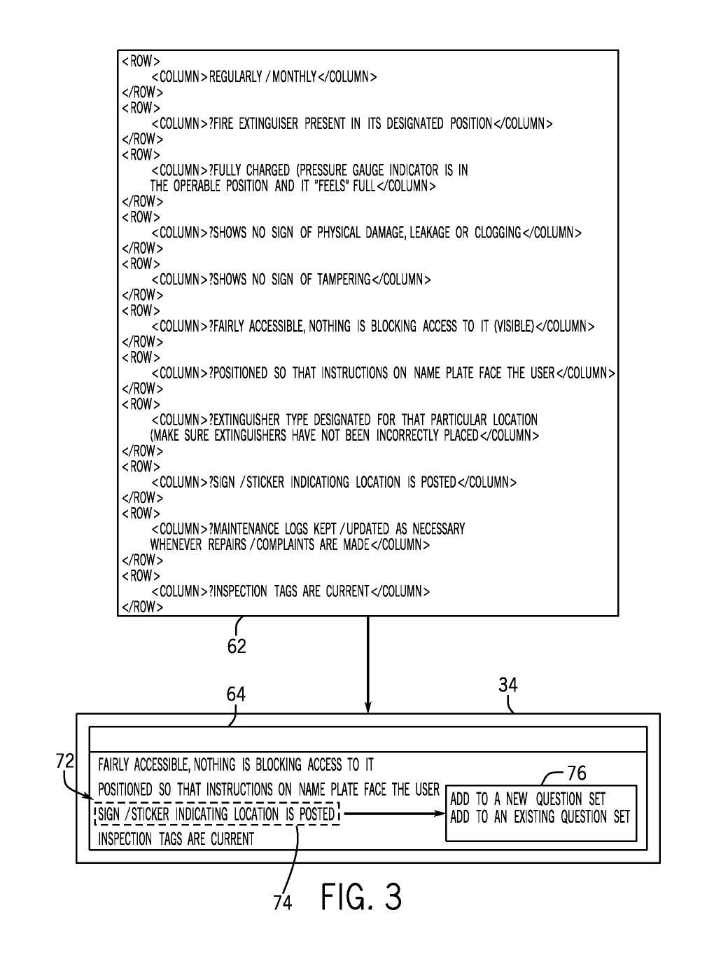

Referring to FIG. 3, the workflow file 62 can be displayed as a web page 64 in HTML format, for example, on display 34. The item list generation application 66 can be used to allow the user to highlight using a mouse, for example, one or more inspection items 72, such as inspection question 74. For example, a popup menu 76 can be used to allow the user to add the one or more selected inspection items 72 to a new item list or to an existing item list.

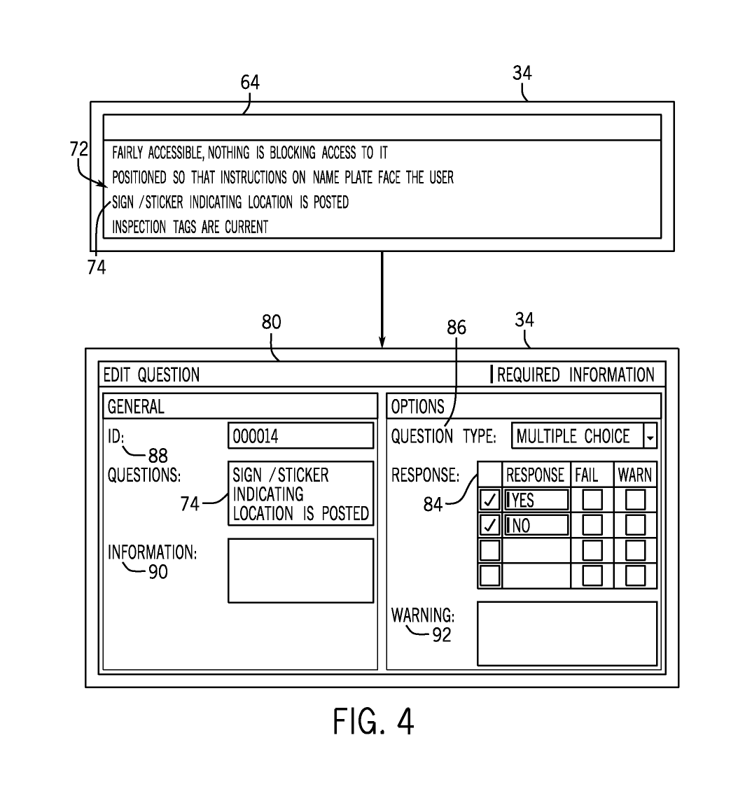

Referring to FIG. 4, each selected inspection item 72 can then be imported into an edit item web page 80 to allow each question 74 and response 84 to be customized, if desired. For example, question type 86, question ID 88, information 90 and warning 92 fields can be included, as non-limiting examples. After each question is edited, the electronic item list 94 can be automatically or manually generated. This process can be repeated until all desired inspection items have been imported into the electronic inspection question set 94.

Referring to FIG. 5, the electronic inspection question set 94 extracted from the electronic file 42 of the paper form 32, can be displayed back to the user on the display 34 for review and final approval. Once the user approves the electronic inspection question set 94, the electronic inspection question set 94 can be saved in the database 70 or other storage for future retrieval and use.

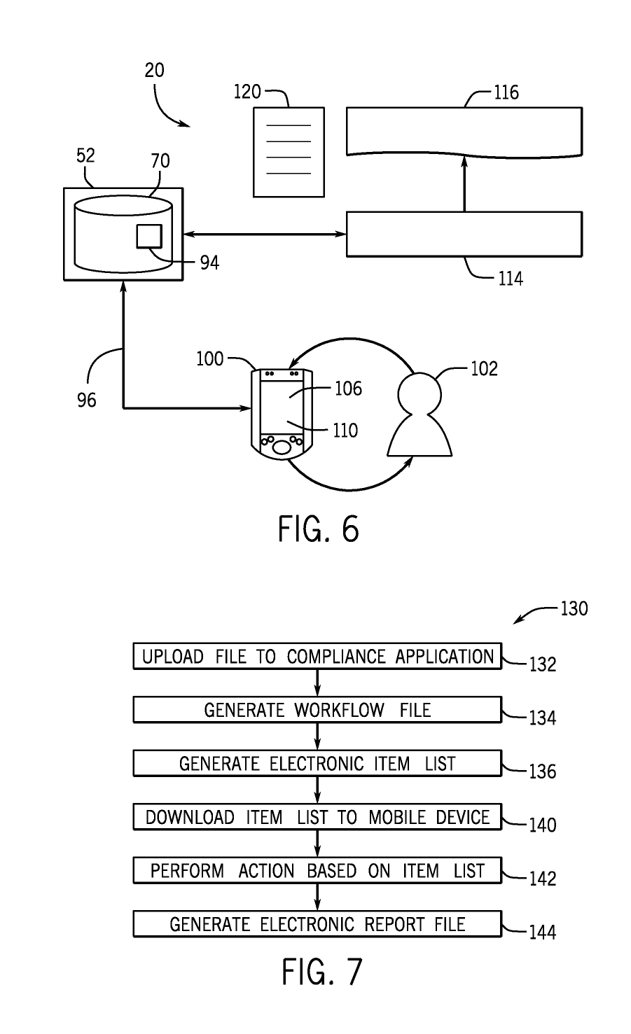

Referring to FIG. 6, the electronic inspection question set 94 from the paper inspection form 32 can now be used by the user 102 whenever an inspection associated with the paper inspection form 32 needs to be performed. The electronic inspection question set 94 can be communicated 96, i.e., wired or wirelessly downloaded, to a mobile device 100 or other computing device for use by the user. A variety of mobile devices 100 are envisioned for use with the system 20. For example, a typical mobile device 100 may comprise a pocket PC scanner, to allow the user to carry a portable device capable of scanning barcodes, passing/failing inspections and triggering incidents, for example. Other mobile devices can be a cell phone, a media player, a tablet, a camera, and/or a laptop computer. The mobile device 100 can communicate 96 wired or wirelessly with the system 20.

The mobile device 100 can include a mobile compliance inspection application 106. Users of the electronic form generation and tracking system 20 can use the mobile device 100 to acquire one or more images (not shown) of the inspected equipment, for example, as part of the record keeping process. The mobile compliance inspection application 106 can allow the user to access the electronic inspection question set 94 and enter collected inspection data 110 using the mobile device 100.

Upon completion of an inspection and/or during the inspection, the inspection results 110 can be communicated 96, i.e., wired or wirelessly uploaded, to the database 70 or other storage. The collected inspection data 110 can then be incorporated with the electronic inspection question set 94 and/or the scanned file 42 using a document generator application 114 to create a completed electronic report file 116 of the paper inspection form 32. It is to be appreciated that the document generator application 114 can be located on the computer system 30 and/or on the mobile device 100. The electronic report file 116 can then be printed as a paper report 120 and/or can be transmitted electronically for electronic submission.

Referring now to FIG. 7, a method 130 is illustrated that is consistent with embodiments of the electronic form generation and tracking system 20 shown in the figures. At process block 132, a user can upload an electronic file 42 to a compliance application 52. The electronic file 42 can be stored in a database 70. In some embodiments, the electronic file 42 can be a scanned image of a paper inspection compliance document 32.

At process block 134, an extraction application 56 can be used to process the electronic file 42 and output an inspection workflow file 62. In some embodiments, the inspection workflow file 62 can be in XML format.

At process block 136, an item list generation application 66 can be used to highlight inspection items from the inspection workflow file 62 that will be used to generate an electronic item list 94. In some embodiments, the electronic item list 94 can be an electronic inspection question set. The electronic item list 94 can be stored in database 70.

At process block 140, the electronic item list 94 can be downloaded to a mobile device 100. Using a mobile compliance inspection application 106, at process block 142, the electronic item list 94 can be accessed and an action can be performed. In some embodiments, the action performed can be a compliance inspection. Collected inspection data 110 can be entered directly into the mobile device 100. In some embodiments, the collected inspection data 110 can be uploaded during or after an inspection.

At process block 144, an electronic report file 116 can be generated. The electronic report file 116 can then be printed as a paper report 120 and/or the electronic report file can be transmitted electronically for electronic submission.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Finally, it is expressly contemplated that any of the processes or steps described herein may be combined, eliminated, or reordered. Accordingly, this description is meant to be taken only by way of example, and not to otherwise limit the scope of this invention.

We claim:

1. An electronic form generation system, the system comprising:
a processor, the processor being operatively coupled to a monitor;
a scanning application in communication with the processor, the scanning application to enable a user to scan a paper form using a scanner and convert the paper form into an electronic file;
a compliance application in communication with the processor, the compliance application to upload the electronic file to a database;
an extraction application, the extraction application to use optical character recognition to process the electronic file to extract and then output an inspection workflow file;
an item list generation application viewable on the monitor, the item list generation application to generate an electronic item list, the item list generation application to allow the user to select at least one inspection item from the inspection workflow file and to add the at least one selected inspection item to the electronic item list, the electronic item list to be stored in the database for future retrieval and use; and
a mobile inspection application operable on a mobile electronic device, the mobile inspection application operable to download and access the electronic item list and to allow the user to enter collected data using the mobile device.

2. The system according to claim 1, wherein the compliance application is at least one of a cloud based application and an Internet based application.

3. The system according to claim 1, wherein the compliance application is accessible using at least one of the processor and a local area network.

4. The system according to claim 1, wherein the electronic item list is an electronic inspection question set.

5. The system according to claim 1, wherein the compliance application is a web based customer portal, and the customer portal requires the user to provide access information.

6. The system according to claim 5, wherein after the user has provided access information, the user then has access to the scanned document upload interface.

7. An electronic compliance form generation system, the system comprising:
a document scanning application operable on a processor, the document scanning application to enable a user to scan a paper compliance form using a scanner and convert the paper compliance form into an electronic file;
an extraction application, the extraction application to use character recognition to process the electronic file to extract and then output a compliance inspection workflow file;
an item list generation application to generate an electronic inspection question set based on the paper compliance form, the electronic inspection question set to be stored in a database for future retrieval and use;
a mobile compliance inspection application operable on a mobile electronic device, the mobile compliance inspection application operable to download and access the electronic inspection question set and to allow the user to enter collected compliance data using the mobile device; and
a document generator application to incorporate the collected compliance data with the electronic inspection question set to create an electronic report file of the paper compliance form.
printing the electronic report file as a paper report, the paper report including the collected inspection data.

8. The system according to claim 7, wherein the electronic report file is printed as a paper report in the form of a completed paper compliance form.

9. The system according to claim 7, wherein the item list generation application allows the user to select at least one inspection item and to add the at least one selected inspection item to the electronic item list or to a new electronic item list.

10. The system according to claim 7, wherein a scanned document upload interface allows the user to browse a plurality of electronic files stored in the database and select one of the plurality of electronic files to process.

11. A method of performing an inspection, the method comprising:
uploading an electronic file to a compliance application, the compliance application including an extraction application and an item list generation application;
using the extraction application to process the electronic file and output an inspection workflow file;
using the item list generation application to highlight an inspection item from the inspection workflow file that will be used to generate an electronic item list;
downloading the electronic item list to a mobile device;
accessing the downloaded electronic item list using a mobile compliance inspection application; and
performing the inspection based on downloaded electronic item list.

12. The method according to claim 11, wherein the electronic file is stored in a database.

13. The method according to claim 11, wherein the electronic file is a scanned image of a paper inspection compliance document.

14. The method according to claim 11, wherein the inspection workflow file is in XML format.

15. The method according to claim 11, further including highlighting textual portions of the inspection workflow file; and
displaying the highlighted textual portions to a user.

16. The method according to claim 11, wherein the electronic item list is an electronic inspection question set.

17. The method according to claim 11, wherein the inspection performed is a compliance inspection.

18. The method according to claim 11, further including collecting inspection data; and
entering the inspection data directly into the mobile device.

19. The method according to claim 18, wherein the collected inspection data is uploaded during or after performing the inspection.

20. The method according to claim 18, further including generating an electronic report file; and
printing the electronic report file as a paper report, the paper report including the collected inspection data.
